(19) United States
(12) Patent Application Publication
(10) Pub. No.: US 2022/0120240 A1
(43) Pub. Date: Apr. 21, 2022

(54) VORTEX THRUSTER SYSTEM INCLUDING CATALYST BED WITH SCREEN ASSEMBLY

(71) Applicant: SIERRA NEVADA CORPORATION, Sparks, NV (US)

(72) Inventors: Ryan Christopher Cavitt, Waunakee, WI (US); William Zach Hallum, Madison, WI (US); Scott Murphy Munson, Monona, WI (US)

(21) Appl. No.: 17/072,620

(22) Filed: Oct. 16, 2020

(51) Int. Cl. F02K 7/08; F02K 9/52

(52) U.S. Cl. CPC F02K 7/08; F02K 9/52

(57) ABSTRACT

Various embodiments of a vortex thruster system is described herein that are configured to create at least three discrete thrust levels. In some embodiments, the vortex thruster system includes a catalyst bed configured to decompose a monopropellant at more than one flow rate and deliver the decomposed monopropellant into a vortex combustion chamber for generating various thrust levels. In some embodiments, the catalyst bed includes a screen assembly positioned within the inner chamber of the catalyst bed. The screen assembly can include alternating reactive screens and inert screens. The reactive screens can include a catalytic coating for assisting with decomposing the monopropellant, and the inert screens can provide structural support for the screen assembly. Related systems, methods, and articles of manufacture are also described.

### TECHNICAL FIELD

The subject matter described herein relates to a vortex thruster system that can generate various thrust levels.

### BACKGROUND

Design requirements for a rocket combustion engine can include competing or conflicting requirements. For example, an efficient rocket combustion chamber can thoroughly mix fuel and oxidizer to generate complete combustion. However, complete combustion can cause intense thermal stress of the rocket engine hardware. A cooling mechanism may be required to prevent overheating, but conventional cooling mechanisms can add weight to a system that is mass-sensitive.

Some rocket engines can achieve high mixing rates and combustion efficiencies through the use of complex propellant injectors that can be heavy and expensive to manufacture. Furthermore, some rocket engines include intricate regenerative coolant channels to remove heat from the rocket hardware. Such rocket engine configurations may be difficult and expensive to manufacture, as well as require an increase in overall size and weight of the rocket engine.

Some rocket engines can include a catalyst bed for decomposing a monopropellant. Such catalyst beds can be configured for a single flow rate of monopropellant into the catalyst bed for decomposing the monopropellant. As such, catalyst beds configured to deliver monopropellant at more than one flow rate can experience either a reduction in monopropellant decomposition effectiveness and/or a reduction in operational lifetime of the catalyst bed.

### SUMMARY

Aspects of the current subject matter include various embodiments of a vortex thruster system that can effectively decompose monopropellant delivered to a catalyst bed at more than one flow rate for generating various thrust levels. In one aspect, the vortex thruster system can include a catalyst bed configured to decompose a monopropellant delivered to an inner chamber of the catalyst bed. The catalyst bed can include a screen assembly positioned within the inner chamber of the catalyst bed, and the screen assembly can include alternating reactive screens and inert screens. The reactive screens can include a catalytic coating for assisting with decomposing the monopropellant, and the inert screens can provide structural support for the screen assembly. The vortex thruster system can further include at least one valve for controlling delivery of the monopropellant into the catalyst bed at more than one flow rate for allowing the catalyst bed to decompose the monopropellant at the more than one flow rates. Furthermore, the vortex thruster system can include a vortex combustion chamber in fluid communication with the catalyst bed and be configured to receive the decomposed monopropellant from the catalyst bed. The decomposed monopropellant can assist with generating thrust.

In some variations one or more of the following features can optionally be included in any feasible combination. In some embodiments, the catalytic coating of the reactive screen includes a silver plating coated with samarium oxide. The catalyst bed can further include at least one baffle ring positioned along an inner wall of the inner chamber to at least one of maintain a packing pressure of the screen assembly and divert monopropellant away from the inner wall of the catalyst bed. The packing pressure can be approximately 2000 psi.

In some embodiments, at least one of the inert screens and at least one of the reactive screens can include a fine weave configuration. The fine weave configuration can include a 50×50 mesh count. At least one of the inert screens and at least one of the reactive screens can include a coarse weave configuration. The coarse weave configuration can include a 10×10 mesh count. The reactive screens can include a first reactive screen including a fine weave configuration and a second reactive screen including a coarse weave configuration. The first reactive screen can be positioned upstream from the second reactive screen.

In some embodiments, the vortex thruster system can further include a heating element positioned along an outer perimeter of the catalyst bed, and the heating element can be configured to assist with controlling a rate of heat loss of the catalyst bed. In some embodiments, the at least one valve can include a first valve and a second valve. In some embodiments, the first valve can be configured to deliver the monopropellant into the catalyst bed at a first flow rate, and the second valve can be configured to deliver the monopropellant into the catalyst bed at a second flow rate. The second flow rate can be greater than the first flow rate. The delivery of the monopropellant at the second flow rate can generate a greater thrust compared to delivery of the monopropellant at the first flow rate. The monopropellant can include hydrogen peroxide or hydrazine.

In another interrelated aspect of the current subject matter, a method can include receiving monopropellant at a first flow rate into an inner chamber of a catalyst bed of the vortex thruster system. The catalyst bed can include a screen assembly positioned within the inner chamber of the catalyst bed, and the screen assembly can include alternating reactive screens and inert screens. The reactive screens can include a catalytic coating for assisting with decomposing the monopropellant, and the inert screens can provide structural support for the screen assembly. The method can further include decomposing the monopropellant flowing through the screen assembly of the catalyst bed and delivering the decomposed monopropellant into a vortex combustion chamber of the vortex thruster system to assist with generating a first thrust level.

In some embodiments, the method can include exposing, before operating the vortex thruster system, the screen assembly to decomposed hydrogen peroxide to activate the reactive screens. In some embodiments, the catalytic coating of the reactive screen can include a silver-plating coated in samarium oxide. The catalyst bed can further include at least one baffle ring positioned along an inner wall of the inner chamber to at least one of maintain a packing pressure of the screen assembly and divert monopropellant away from an inner wall of the catalyst bed.

The reactive screens can include a first reactive screen including a fine weave configuration and a second reactive screen including a coarse weave configuration. The first reactive screen can be positioned upstream from the second reactive screen. The method can further include activating a second monopropellant valve to deliver the monopropellant at a second flow rate to the catalyst bed, and the second flow rate can be greater than the first flow rate. The delivery of the monopropellant at the second flow rate can create a second thrust level that is greater than the first thrust level.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a first section view of an embodiment of a vortex thruster system consistent with implementations of the current subject matter;

FIG. 2 illustrates a second section view of the vortex thruster system of FIG. 1 showing a first propellant valve and a second propellant valve in fluid communication with a catalyst bed;

FIG. 3 illustrates a partial section view of the vortex thruster system of FIG. 1 showing a fluid pathway between a secondary propellant injector and a vortex combustion chamber, as well as fluid pathways between the catalyst bed and the vortex combustion chamber;

FIG. 4A illustrates a cross-section view of an embodiment of the catalyst bed including a screen assembly;

FIG. 4B illustrates a magnified partial view of an embodiment of a screen of the screen assembly of FIG. 4A and showing a coarse weave configuration;

FIG. 4C illustrates a magnified partial view of an embodiment of a screen of the screen assembly of FIG. 4A and showing a fine weave configuration;

FIG. 4D illustrates a cross-section diagram view of an embodiment of the screen assembly of FIG. 4A; and

FIG. 4E illustrates a side perspective view of an embodiment of a baffle of the screen assembly of FIG. 4A.

When practical, similar reference numbers denote similar structures, features, or elements.

### DETAILED DESCRIPTION

Various embodiments of a vortex thruster system are described herein that can be included in various propulsion systems and can provide an efficient and effective way to generate various thrust levels. For example, the vortex thruster system can be configured to efficiently generate at least three discrete thrust levels, such as a high thrust level, a medium thrust level, and a low thrust level. Additionally, the vortex thruster system can be configured to generate a swirling or vortex flow field in a combustion chamber to limit thermal loading of the hardware of the vortex thruster system. Various vortex thruster system embodiments are described in greater detail below.

In some embodiments, the vortex thruster system can include a catalyst bed and at least one oxidizer or monopropellant injector configured to deliver a monopropellant into the catalyst bed. The catalyst bed can be configured to decompose the monopropellant, such as decompose hydrogen peroxide into high-temperature water vapor and gaseous oxygen. The catalyst bed can be in communication with a vortex combustion chamber such that the decomposed monopropellant formed in the catalyst bed can be delivered into the vortex combustion chamber. Delivery of the decomposed monopropellant into the vortex combustion chamber can generate thrust by exhausting the products of decomposition through a nozzle extending from the vortex combustion chamber.

In some embodiments, the vortex thruster system can control a flow rate at which the monopropellant is delivered to the catalyst bed, which can affect the amount of thrust generated at the nozzle. For example, the vortex thruster system can include a first monopropellant valve and a second monopropellant valve that are each configured to deliver the monopropellant at a different flow rate. For example, a greater flow rate of the monopropellant into the catalyst bed can result in a greater generated thrust.

Various embodiments of the catalyst bed are described herein that are configured to effectively decompose the monopropellant at more than one flow rate. For example, the catalyst bed can include a screen assembly that assists with effectively distributing the monopropellant within the catalyst bed and controlling where a decomposition plane along the screen assembly is achieved for a given flow rate of the monopropellant. Distribution of the monopropellant within the catalyst bed and controlling the location of decomposition planes to coincide with increasing coarseness of the screens of the screen assembly can allow the catalyst bed to effectively decompose monopropellant delivered to the catalyst bed at multiple flow rates. Additionally, performing an initiation process described herein with the catalyst bed including the screen assembly can further allow the catalyst bed to operate efficiently over a sufficiently long operational lifetime. For example, the initiation process can include activating reactive screens of the screen assembly prior to operation of the catalyst bed. Some embodiments of the catalyst bed described herein can include a thermal management system that can limit thermal cycling fatigue and promote operational longevity of the catalyst bed.

In some embodiments, the vortex thruster system can include a secondary propellant valve that directly injects a secondary propellant (e.g., a kerosene) into the vortex combustion chamber to ignite with the decomposed monopropellant in a bi-propellant configuration to generate a highest thrust level that can be achieved by the vortex thruster system.

Furthermore, in some embodiments the vortex combustion chamber can include at least one tangential injection port, such as at least an array of tangential injection ports, that are configured to deliver the decomposed monopropellant in a direction tangential to a circumference of an inner cylindrical surface of the vortex combustion chamber. This tangential injection can cause a flow of the decomposed monopropellant to swirl in the vortex combustion chamber. The swirl flow may translate upwards towards the proximal end of the vortex combustion chamber where the flow can turn inward and move spirally away from a closed proximal end of the vortex combustion chamber, down the center of the vortex combustion chamber, and out the nozzle.

In some embodiments, the vortex thruster system may include at least one axial proximal injection port for delivering a portion of the decomposed monopropellant into a center area of the vortex combustion chamber. This may assist with efficiently and effectively optimizing the vortex combustion chamber for achieving a desired thrust level while simultaneously limiting the thermal load on the thruster hardware. As described herein, a thrust level can include an approximate range of thrust loads, such as a low thrust level including a first thrust load range (e.g., approximately 20 lbf to 40 lbf), a medium thrust level including a second thrust load range (e.g., approximately 50 lbf to 65 lbf), and a high thrust level including a third thrust load range (e.g., approximately 100 lbf to 120 lbf). Other thrust levels and thrust load ranges are within the scope of this disclosure.

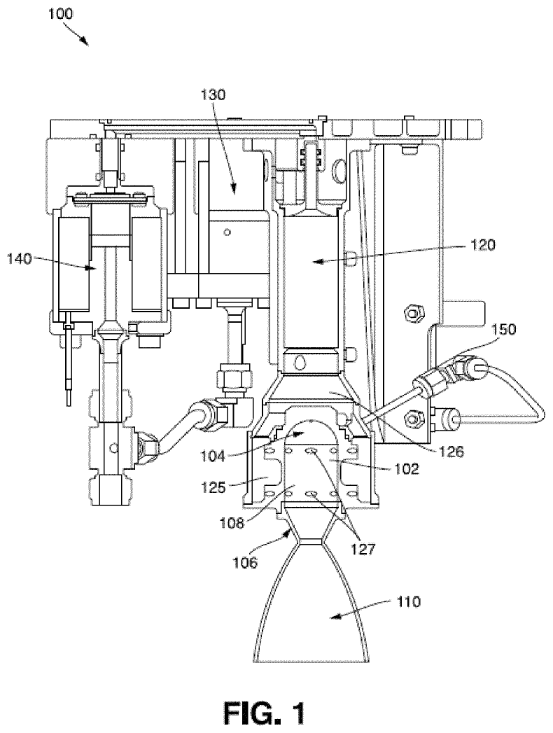

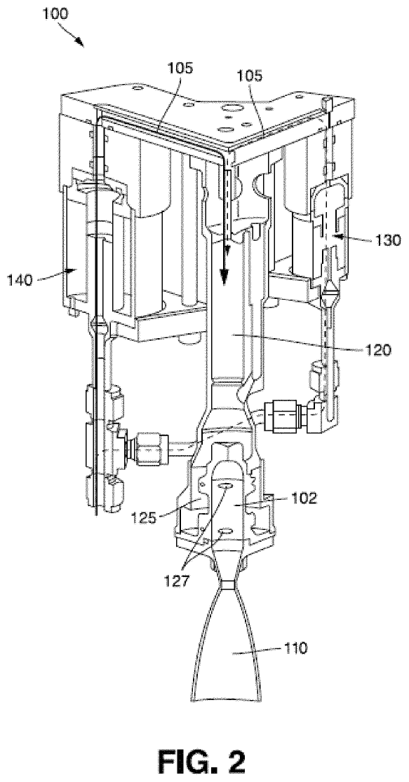

FIGS. 1-3 illustrate an embodiment of a vortex thruster system 100 configured to efficiently and effectively generate at least three discrete thrust levels. As shown in FIG. 1, the thruster system 100 can include a vortex combustion chamber 102 having a proximal end 104, a distal end 106, and a sidewall 108 extending between the proximal end 104 and distal end 106. The vortex combustion chamber 102 may be cylindrical in shape, as shown in FIG. 1, however, other shapes are within the scope of this disclosure. For example, the proximal end 104 of the vortex combustion chamber may include a hollow dome-shape and the distal end 106 may include a converging-diverging nozzle 110 that provides a passageway through the distal end 106 of the vortex combustion chamber 102, as shown in FIG. 1.

As shown in FIG. 1, the vortex thruster system 100 may include a catalyst bed 120 and at least one monopropellant valve, such as a first monopropellant valve 130 and a second monopropellant valve 140, in communication with the catalyst bed 120. In some embodiments, the first monopropellant valve 130 is configured to provide a different flow rate of monopropellant 105 into the catalyst bed 120 compared to the second monopropellant valve 140. For example, the first monopropellant valve 130 can provide a lower flow rate of monopropellant to allow the vortex thruster system 100 to generate a first, lower thrust level. Additionally, the second monopropellant valve 130 can provide a higher flow rate of monopropellant to allow the vortex thruster system 100 to generate a higher, second thrust level that is greater than the first, lower thrust load.

The catalyst bed 120 can be configured to decompose the monopropellant 105 as it flows axially through the catalyst bed 120. The decomposed monopropellant 107 can then be delivered into the vortex combustion chamber 102 to assist with generating thrust, as will be described in greater detail below. In some embodiments, the monopropellant 105 can include a liquid hydrogen peroxide (e.g., 90% hydrogen peroxide) and the decomposed monopropellant 107 can include water vapor and gaseous oxygen. Other monopropellants (e.g. hydrazine) are within the scope of this disclosure.

At least some presently available catalyst beds can provide efficient decomposition of monopropellant 105 and have a sufficient operational life (e.g., several flight missions). However, such catalyst beds can be limited to a single flow rate of monopropellant to achieve efficient decomposition and sufficient operational life. As such, at least some currently available catalyst beds experience reduced efficiency and operational life when more than one flow rate of monopropellant 105 is delivered to the catalyst bed 120.

As will be described in greater detail below, the vortex thruster system 100 described herein is configured to be able to deliver at least two different flow rates of monopropellant 105 to the catalyst bed 120. As such, the present disclosure describes various embodiments of the catalyst bed 120 including features that allow the catalyst bed 120 to efficiently decompose monopropellant 105 delivered to the catalyst bed 120 at more than one flow rate, as well as maintain sufficient operational life of the catalyst bed 120, such as compared to a catalyst bed 120 configured for a single flow rate of monopropellant 105. The flow rates referenced herein can include a single flow rate and/or a narrow range of flow rates to achieve a thrust level generated by the vortex thruster system 100.

For example, the vortex thruster system 100 can be configured to generate at least three different thrust levels that each generate discrete thrust loads or load ranges. For example, the vortex thruster system 100 can generate a low thrust level (e.g., generates approximately 40 lbf), a medium thrust level (e.g., generates approximately 65 lbf), and a high thrust level (e.g., generates approximately 110 lbf). For example, the low thrust level can be achieved by activating the first monopropellant valve 130 thereby delivering the monopropellant at a first, lower flow rate (e.g., approximately 0.246 lbm/sec) into the catalyst bed 120. Additionally, the medium thrust level can be achieved by activating the second monopropellant valve 140 thereby delivering the monopropellant at a second, greater flow rate (e.g., approximately 0.400 lbm/sec) into the catalyst bed 120. Furthermore, for example, the high thrust level can be achieved by activating the second monopropellant valve 140 (e.g., delivering the monopropellant at approximately 0.341 lbm/sec) and an additional valve that can deliver a secondary propellant directly into the vortex combustion chamber 102, as will be described in greater detail below.

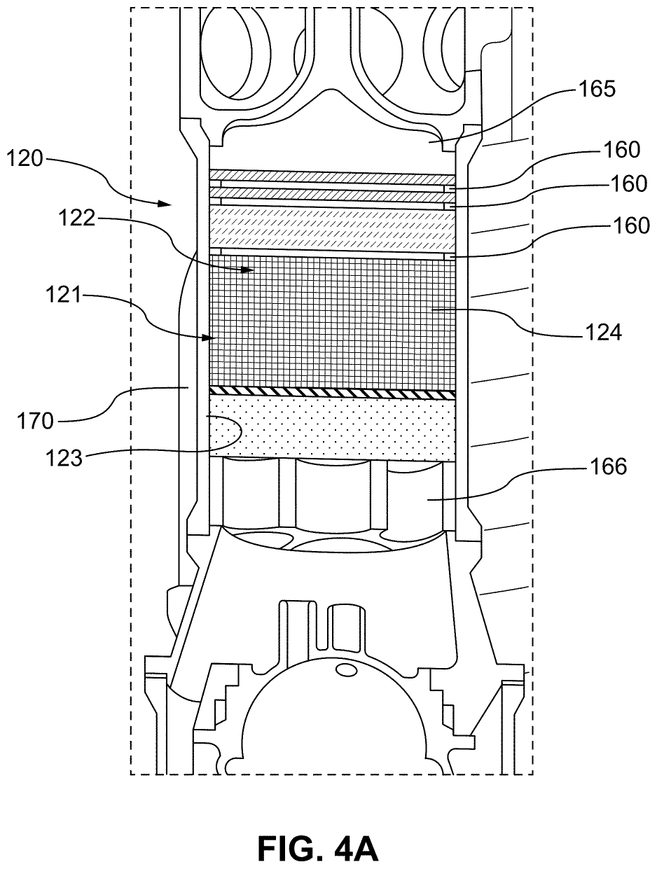

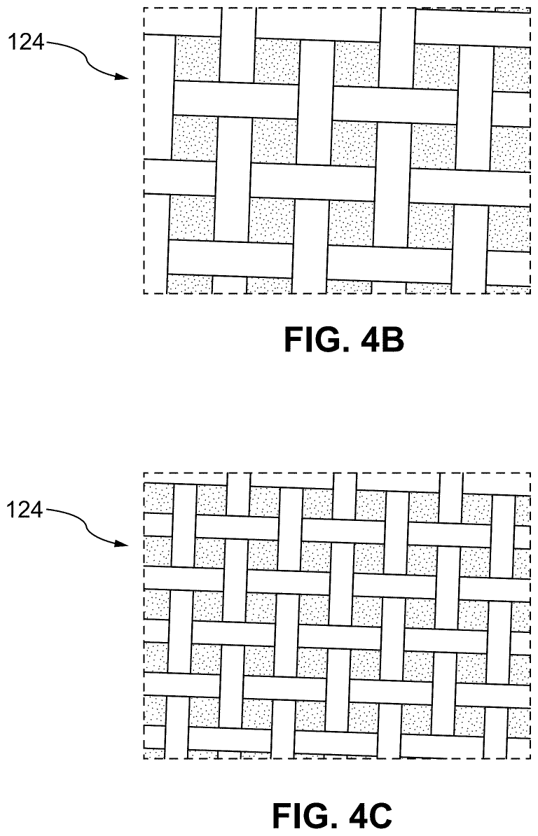

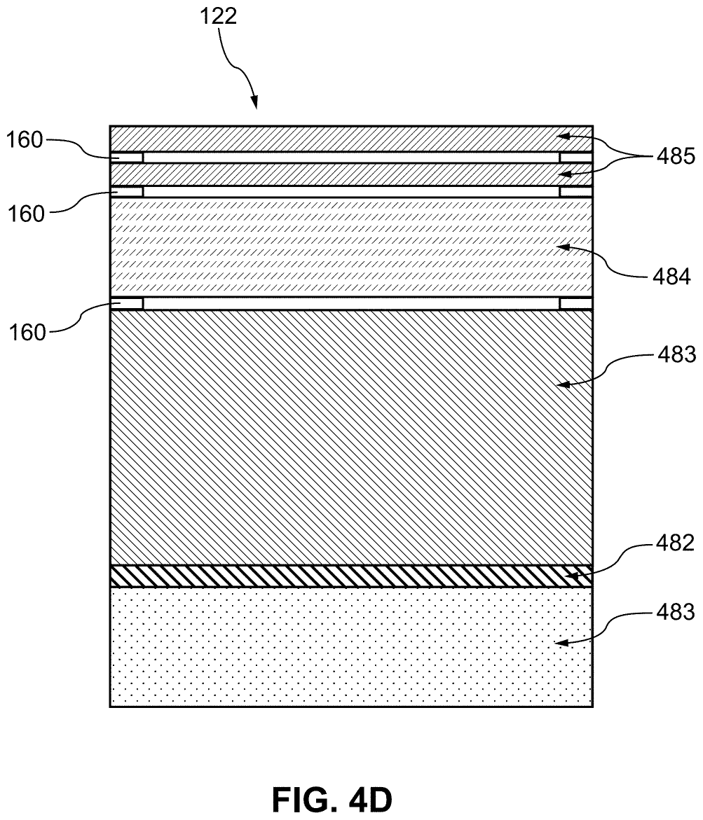

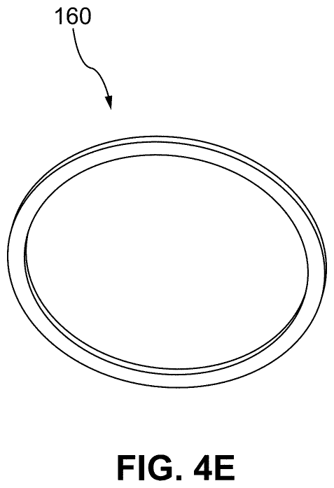

FIG. 4A illustrates an embodiment of the catalyst bed 120 including an embodiment of a screen assembly 122 positioned within an inner chamber 121 of the catalyst bed 120. The screen assembly 122 can be configured to distribute the monopropellant 105 within the inner chamber 121 of the catalyst bed 120 and to achieve a desired decomposition plane that is based on a flow rate of the monopropellant 105 being introduced into the inner volume 121 of the catalyst bed 120.

For example, the catalyst bed decomposition plane can be defined as an axial location within the inner chamber 121 of the catalyst bed 120 at which the monopropellant has primarily transitioned from a liquid to a gas. This axial location can be experimentally determined, for example, by measuring fluid temperatures within the inner chamber 121 or by measuring a temperature of an exterior portion of the catalyst bed 120. In some embodiments, the axial location of the decomposition plane can be determined by measuring a change in pressure between axial locations along the catalyst bed 120. The axial location of the decomposition plane can affect the longevity and effectiveness of at least the catalyst bed 120. For example, if the decomposition plane is too high (e.g., upstream) in the catalyst bed 120, the gas-phase propellant can incur an elevated pressure drop and a propellant feed system may not be able to support the pressure schedule. Also, a higher decomposition plane can expose more catalyst screens of the screen assembly 122 to high temperature products of decomposition, which can result in a reduction in catalyst life. Furthermore, if the decomposition plane is too low (e.g., downstream), the decomposition of the monopropellant may be incomplete, such as if a low-temperature or low-concentration monopropellant is delivered to the catalyst bed 120.

A reduction in decomposition efficiency can result in a reduction in delivered thrust and delivered specific impulse. The axial location of the decomposition plane can be controlled by modulating the reactivity of the individual catalyst screens of the screen assembly 122 through the chemical treatments of the screens, such as by varying the catalyst bed loading factor (e.g., the monopropellant mass flow rate divided by the internal planform area of the catalyst screens), and/or by changing the sequence of reactive/non-reactive screens and coarse/fine screens in the screen assembly 122.

Various embodiments of the screen assembly 122 are described herein, including various ways to manufacture parts of the screen assembly 122. Additionally, treatment processes of the catalyst bed 120 are described herein that assist with preparing the catalyst bed 120 to efficiently decompose the monopropellant 105 and achieve desired operational lifetimes.

As shown in FIGS. 4A, the screen assembly 122 can include a plurality of screens 124 that are stacked along a longitudinal axis of the inner volume 121 of the catalyst bed 120. Each screen 124 can include a flat woven structure having an outer perimeter that includes a same or similar shape as a perimeter shape of an inner wall 123 defining the inner chamber 121 of the bed 120. For example, the perimeter shape of the inner wall 123 and the outer perimeter of the screen 124 can be circular, however, other shapes are within the scope of this disclosure. In some embodiments, the outer perimeter of each screen 124 can have an approximately same or similar diameter as the perimeter of the inner wall 123 of the catalyst bed 120. In some embodiments, each screen 124 can include a circular shape and a diameter that is approximately 1.3 inch to approximately 1.4 inch, however, other sizes are within the scope of this disclosure.

FIGS. 4B and 4C illustrate embodiments of woven structures that can form one or more screens 124 of the screen assembly 122. For example, each screen 124 of the screen assembly 122 can be formed out of a plurality of wires that are woven together to form a plain weave woven structure, such as shown in FIGS. 4B and 4C. Other types of weaves are within the scope of this disclosure. Additionally, the woven structures of the screens 124 can include various weave configurations, such as coarse weave configurations (e.g., as shown in FIG. 4B) or fine weave configurations (e.g., as shown in FIG. 4C). For example, the fine weave configuration can include at least a 30×30 mesh count and a coarse weave configuration can include a mesh count that is less than or equal to a 20×20 mesh count. For example, the wire of the screen 124 can include a diameter that is approximately 0.009 inch to approximately 0.025 inch. The wire material can include one or more of a variety of materials, such as a metal material (e.g., silver). In some embodiments, the screens 124 can include a Monel® 400 screen with an approximately 50 micron thick silver plating. Other weave configurations and wire materials are within the scope of this disclosure.

For example, screens 124 having a coarse mesh can provide more flow area for liquid and gaseous propellants to flow through, thus reducing a pressure drop across the course mesh screen 124. The course mesh can also have less surface area available for catalysis, thus retarding the decomposition process. By putting screens 124 having a coarser mesh lower in the catalyst bed 120 (e.g., downstream), the decomposition process can be throttled to position the decomposition plane at a target axial location along the catalyst bed 120.

The screen assembly 122 can include at least one screen 124 having a surface treatment for assisting with decomposing the monopropellant 105. For example, the screen assembly 122 can include at least one reactive screen 125 including a partial samarium oxide surface coating. For example, the samarium oxide surface coating can act as a mask over a silver plating on the screen 124. By masking a portion of the silver plating, the undecomposed monopropellant 105 can more easily and effectively reach the silver catalysis sites, thus making the reactive screen 125 more reactive compared to a reactive screen that did not have a partial samarium oxide surface coating. Additionally, the screen assembly 122 can include at least one inert screen 126 that does not include a surface coating and can provide structural support to the screen assembly 122, such as to resist thermal and compressive loads that can occur during operation of the vortex thruster system 100. The inert screens 126 can also serve to redistribute the flow of monopropellant 105 and allow fresh, undecomposed monopropellant 105 to reach the catalysis sites on subsequent reactive screens 125.

In some embodiments, the screen assembly 122 can include a plurality of inert screens 126 having more than one weave configuration and a plurality of reactive screens 125 having more than one weave configuration. Furthermore, each of the reactive screens 125 in the screen assembly 122 can be separated by at least one inert screen 126, such as to throttle the decomposition process and provide a more uniform flow through the catalyst bed 120, which is indicated for flow stability. For example, flow instability or chugging can occur when incoming monopropellant 105 rapidly decomposes and causes the inlet pressure to spike, which can prevent fresh monopropellant 105 from entering the catalyst bed 120. When the pressure spike subsides, the fresh incoming monopropellant 105 can rapidly decompose and start the cycle anew. This flow instability can occur, for example, at a frequency of approximately 100 Hz. In contrast, inert screens 126 can be stacked next to each other without negatively effecting the catalyst bed 120. For example, some embodiments of the screen assembly 122 include at least two inert screens 126 stacked next to each other. In some embodiments, one or more inert screens 126 can be positioned adjacent an outlet of the catalyst bed 120 to complete the reaction through thermal decomposition. Additionally, inert screens 126 positioned adjacent the outlet of the catalyst bed 120 can include a course weave to assist with minimizing a pressure drop across such inert screens 126, as well as increase resistance time in the catalyst bed to allow thermal decomposition to be completed.

In some embodiments, the stacked screens of the screen assembly 122 can be compressed along the length of the screen assembly 122. For example, during manufacturing of the screen assembly, the screens 124 can be stacked in the inner chamber 121 of the catalyst bed 120 and a packing pressure can be applied to one end of the stack of screens 124 to thereby compress the stack of screens 124. For example, the packing pressure applied to the stack of screens 124 for maintaining along the screen assembly 122 can be approximately 2000 psi. Some embodiments of the catalyst bed 120 can include one or more features for assisting with maintaining the packing pressure along at least a part of the screen assembly 122.

As shown in FIG. 4A, the catalyst bed 120 can include at least one baffle 160 extending along at least a part of the inner wall of the inner volume 121 of the catalyst bed 120. The baffle 160 can have a ring shape with an outer diameter that is approximately the same as the diameter of the inner wall 123 of the inner chamber 121. As such, the outer diameter of the baffle 160 can have a compression and/or friction fit with the inner wall 123 of the inner chamber 121 to secure a position of the baffle 160 along the inner wall 123 of the catalyst bed 120 and maintain the packing pressure along at least a part of the screen assembly 122. The baffle 160 can also prevent monopropellant 105 passage between the inner wall 123 of the catalyst bed and an adjacent screen 124, as well as direct the monopropellant 105 towards the center or longitudinal axis of catalyst bed 120. Some embodiments of the catalyst bed 120 can include two or more baffles 160, such as three baffles 160, as shown in FIG. 4A. For example, each baffle 160 can be ring-shaped and include a thickness that is smaller than a width of the ring-shaped baffle 160, as shown in FIG. 4D.

In some embodiments, the screens 124 of the screen assembly 122 can be oriented in a same or similar orientation, such as normal or perpendicular to the longitudinal axis of the catalyst bed 120. The screens 124 may also be rotationally oriented the same or similarly. However, some embodiments may include one or more screens 124 having a different rotational orientation compared to other screens 124 within the screen assembly 122. For example, at least one screen 124 can be rotationally offset from another screen 124 by approximately 45 degrees. For example, by alternating adjacent screen orientations approximately zero degrees and approximately 45 degrees, an available surface area can be increased and undesired nesting of adjacent screens 124 can be reduced or prevented. Such alternating between screens 124 can also encourage additional interaction time between the monopropellant 105 and the screens 124, which can result in increased catalyst bed efficiency.

In some embodiments, a base of the catalyst bed 120 can include a support plate 166, as shown in FIG. 4A. For example, the support plate 166 can assist with defining the inner chamber 121 of the catalyst bed 120 and provide support for the screen assembly 122, including assisting with maintaining the packing pressure of the screen assembly 122. In some embodiments, manufacturing of the screen assembly 122 can include forming a plurality of screen layers along the length of the inner chamber 121 of the catalyst bed 120. Each screen layer can include one or more screens 124 including the same or similar weave configuration (e.g., coarse, fine, etc.). The screen layers can assist with controlling the axial position of the decomposition place and promote effective decomposition of the monopropellant 105.

As shown in FIG. 4D, the screen assembly 122 can include a first screen layer 481 positioned above and upstream from the support plate 166. The first screen layer 481 can also be the furthest downstream along the screen assembly 122. In some embodiments, the first screen layer 481 can be the first screen layer assembled and formed within the catalyst bed 120, however, other screen assembly manufacturing processes are within the scope of this disclosure.

In some embodiments, the first screen layer 481 of the screen assembly 122 can include a plurality of coarse mesh inert screens 126, such as approximately 10 to 15 inert screens 126 each having a 10×10 mesh count. As shown in FIG. 4D, the screen assembly 122 can include a second screen layer 482 positioned upstream and adjacent to the first screen layer 481. The second screen layer 482 can include one or more inert screens 126 that are less coarse compared to the first layer 481. For example, the second screen layer 482 can include one inert screen 126 having a 20×20 mesh count.

As shown in FIG. 4D, the screen assembly 122 can include a third screen layer 483 positioned upstream and adjacent to the second layer 482. The third screen layer 483 can include a plurality of alternating reactive screens 125 and inert screens 126. For example, the third screen layer 483 can include approximately 25-35 screens 124 including alternating inert screens 126 and reactive screens 125 each having a 20×20 mesh count.

As shown in FIG. 4D, the screen assembly 122 can include a fourth screen layer 484 positioned upstream and adjacent to the third layer 483. The fourth screen layer 484 can include a plurality of alternating reactive screens 125 and inert screens 126. For example, the fourth screen layer 484 can include approximately 14-18 screens 124 including alternating inert screens 126 and reactive screens 125 each having a 30×30 mesh count or a mesh count that is more fine compared to the screens 124 in the third screen layer 483.

As shown in FIG. 4D, the screen assembly 122 can include a fifth screen layer 485 positioned upstream and adjacent to the fourth screen layer 484. The fifth screen layer 485 can include at least two inert screens 126 that are more fine compared to the fourth layer 484. For example, the fifth layer can include 3-5 inert screens 126 having a 50×50 mesh count. Such fine weave configurations in the upstream portion of the catalyst bed 120 can cause a wide and uniform distribution of the monopropellant throughout the cross-sectional flow area of the inner chamber 121 of the catalyst bet 120, such as along at least the fifth layer 485 and as the monopropellant flows into the fourth layer 484. Such wide and uniform distribution of the monopropellant through screen layers including reactive screens 125 can assist with efficient and effective decomposing of the monopropellant 105 and achieving the desired operational life of the catalyst bed 120.

As shown in FIG. 4D, one or more baffles 160 can be positioned between and/or within one or more screen layers, such as to assist with maintaining a desired packing pressure (e.g., 2000 psi) along the screen assembly 122. For example, a baffle 160 can be positioned between the third screen layer 483 and the fourth screen layer 484 and between the fourth screen layer 484 and the fifth screen layer 485, as shown in FIG. 4D. Furthermore, a baffle 160 can be positioned within the fifth layer 485, such as between two or more inert screens 126 of the fifth layer 485. Other baffle 160 placements and configurations are within the scope of this disclosure.

In some embodiments, a top portion of the catalyst bed 120 can include an injector plate 165, as shown in FIG. 4A. For example, the injector plate 165 can assist with defining the inner chamber 121 of the catalyst bed 120 and assist with maintaining compression of the screen assembly 122. As shown in FIG. 4D, the fifth screen layer 485 can be positioned downstream and adjacent to the injector plate 165. The injector plate 165 can also provide uniform distribution of propellant across the catalyst bed 120. The injector plate 165 can also provide sufficient stiffness to the propellant injection such that pressure perturbations downstream can have less impact on an overall mass flow rate.

As discussed above, the reactive screen 125 can include a catalytic coating, such as a samarium oxide coating. For example, manufacturing of the reactive screen 125 can include forming a screen material (e.g., Monel® 400 screen) into a predefined size and shape, such as a circular shape having a diameter that is approximately 1.3 inch to approximately 1.4 inch. Once formed into the predefined size and shape, the screen material can be coated in a silver material, such as by using an electroplating process. The silver-plated screen material can then be dipped or submerging in nitric acid (e.g., dipped or submerged for approximately 1 second to 2 seconds), which can increase surface roughness and increase surface area of the screen material. After submerging the screen material in nitric acid, the screen material can be coated with samarium nitrate and then heated (e.g., to at least approximately 650 degrees Fahrenheit, such as 900 degrees Fahrenheit, for approximately 5 minutes). Such heating can convert the samarium nitrate into samarium oxide. In some embodiments, the following steps can be repeated 3 or 4 additional times: the screen material can be dipped or submerged in nitric acid, the screen material can then be coated in samarium nitrate, and then the screen material can be heated. Any of the manufacturing steps can be repeated one or more times and additional steps can be included for forming the reactive screen 125 without departing from the scope of this disclosure. After the reactive screen 125 is formed, the reactive screen 125 can be packed into the catalyst bed 120 to form a part of the screen assembly 122.

In some aspects, the catalyst bed 120 can undergo an initiation process prior to operative use of the catalyst bed 120 vortex thruster system 100. For example, the catalyst bed 120 can be exposed to hydrogen peroxide at a flow rate below operational conditions. Such exposure can activate the reactive screens 125 thereby making the reactive screens 125 more reactive for decomposing the monopropellant 105 during operative use of the catalyst bed 120. As such, the initiation process of the catalyst bed 120 can result in a more effective and efficient catalyst bed 120 for generating various levels of thrust.

Some embodiments of the catalyst bed 120 include a thermal management system, which can include one or more heating elements 170 coupled to a part of the catalyst bed 120. For example, a plurality of heating elements 170 can be coupled to an outer perimeter of the catalyst bed 120 (e.g., outer wall of the catalyst bed 120). For example, the heating elements 170 can include a resistive heating element that provides conductive heat to the catalyst bed 120 during and/or after operation of the vortex thruster system 100, such as to limit thermal cycling fatigue and promote longevity of the catalyst bed 120. In some embodiments, the heating elements 170 can be used to manage thermal loading of the catalyst bed 120, such as by decreasing a rate of heat loss during thermal cycles. For example, controlling the cooling rate of the catalyst bed 120 can allow multiple materials to contract and expand in unison, which can limit shrinking of the catalyst bed 120 and thus limit or prevent a reduction in operational lifetime. In some embodiments, the thermal management system can include a resistance temperature detector to provide closed-loop control of the catalyst bed 120 temperature. For example, the thermal management system can maintain a temperature of the catalyst bed 120 within a temperature range of approximately 300° F. to approximately 350° F.

As will be described in greater detail below, the vortex thruster system 100 includes various features and functions for delivering multiple flow rates of monopropellant 107 to the catalyst bed 120 for generating various levels of thrust.

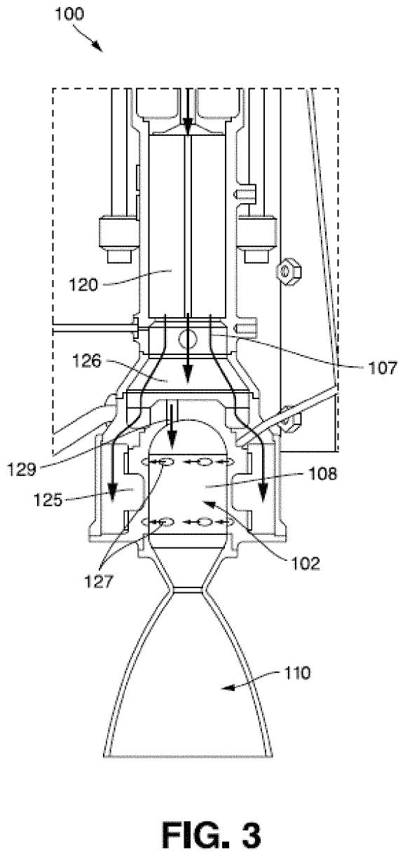

As shown in FIGS. 1 and 3, some embodiments of the vortex thruster system 100 can include an annular chamber 125 positioned around at least a part of the vortex combustion chamber 102 and in fluid communication with an outlet of the catalyst bed 120. The annular chamber 125 can allow the decomposed monopropellant 107 to enter the vortex combustion chamber by passing through at least one array of tangential injection ports 127 positioned along the sidewall 108 of the vortex combustion chamber 102, as shown in FIG. 3. The vortex thruster system 100 can include a proximal chamber 126 for allowing the decomposed monopropellant 107 to be injected into a proximal end of the vortex combustion chamber 102 through at least one proximal injection port 129, as also shown in FIG. 3. Any number of chambers and injectors can be included in the vortex thruster system 100 for directing and controlling the delivery of the decomposed monopropellant 107 into the vortex combustion chamber 102.

As shown in FIGS. 1 and 3, at least one array of tangential injection ports 127 may be positioned along the sidewall 108 of the vortex combustion chamber and configured to direct the decomposed monopropellant 107 at a direction that is tangential to the circumference of the inner cylindrical surface of the sidewall 108 of the vortex combustion chamber 102. This creates a swirling or vortex flow field of the decomposed monopropellant 116 along an outer circumference of the vortex combustion chamber 102. Such swirling can improve combustion efficiency and control hardware temperatures by shielding the vortex combustion chamber walls from high-temperature products of combustion.

As shown in FIGS. 1 and 3, at least one proximal injection port 129 may be axially positioned along the proximal end 104 of the vortex combustion chamber 102. For example, the proximal injection port 129 may be positioned approximately parallel to or along a longitudinal axis of the vortex combustion chamber 102. The proximal injection port 129 may be configured to deliver a portion of the decomposed monopropellant 107 into a combustion zone at or near the centerline of the vortex combustion chamber 102 (e.g., along a longitudinal axis of the vortex combustion chamber). The proximal injection port 129 may provide a trim function that can balance mixing and cooling functions of the vortex flow field.

As shown in FIG. 1, some embodiments of the vortex thruster system 100 can include a secondary propellant valve 150 configured to directly inject a secondary propellant (e.g., kerosene, such as RP-1 kerosene) directly into the vortex combustion chamber 102. Other secondary propellants (e.g., mixed oxides of nitrogen (MON)) are within the scope of this disclosure. As shown in FIG. 1, the secondary propellant can be delivered to a proximal end of the vortex combustion chamber. The secondary propellant can mix with high-temperature products of the decomposed monopropellant in the vortex combustion chamber to generate a desired thrust level (e.g., a high thrust mode).

As discussed above, the vortex thruster system 100 can be configured to generate at least three different thrust levels that each generate discrete thrust load ranges. For example, the vortex thruster system 100 can generate a low thrust level (e.g., generates approximately 40 lbf), a medium thrust level (e.g., generates approximately 65 lbf), and a high thrust level (e.g., generates approximately 110 lbf). For example, the low thrust level can be achieved by activating the first monopropellant valve 130 thereby delivering the monopropellant at a first, lower flow rate into the catalyst bed 120. Additionally, the medium thrust level can be achieved by activating the second monopropellant valve 140 thereby delivering the monopropellant at a second, greater flow rate into the catalyst bed 120. Furthermore, the high thrust level can be achieved by activating the second monopropellant valve 140 as well as the secondary propellant valve 150 to allow the secondary propellant to mix and ignite with the decomposed monopropellant 107 in the vortex combustion chamber 102.

For example, during operation of the vortex thruster system 100 to achieve a low, medium, or high thrust level, liquid hydrogen peroxide can be injected into the catalyst bed 120 where the liquid hydrogen peroxide exothermically decomposes into gaseous oxygen and water vapor as it flows axially through the catalyst bed 120, including through the screen assembly 122 of the catalyst bed 120. Additionally, upon exiting the catalyst bed 120, the decomposed monopropellant 107 can be approximately 1,400 degrees Fahrenheit and can flow into the annular chamber 125 and/or proximal chamber 126 surrounding the vortex combustion chamber 102. The hot oxidizing gas (e.g., the decomposed monopropellant 107) can then enter the vortex combustion chamber 102 through the array of tangential injection ports 127 and/or the proximal injection port 129. The result of the decomposed monopropellant in the vortex combustion chamber can result in the flow of hot gas through the nozzle 110 (e.g., niobium nozzle) and the generation of monopropellant thrust (e.g., low or medium thrust levels).

Furthermore, to generate the high thrust level, a secondary propellant (e.g., kerosene) can be added to vortex combustion chamber 102 to allow mixing and burning of the secondary monopropellant and decomposed monopropellant in the vortex combustion chamber 102. The products of such mixing and burning can result in combustion flow through the nozzle 110 (e.g., niobium nozzle) and generation of bipropellant thrust. In some embodiments, the nozzle 110 may be coated with a silicide coating that can protect against oxidation of the niobium. Other features, functions and benefits of the vortex thruster system 100 are within the scope of this disclosure.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A vortex thruster system, comprising:
a catalyst bed configured to decompose a monopropellant delivered to an inner chamber of the catalyst bed, the catalyst bed comprising:
a screen assembly positioned within the inner chamber of the catalyst bed, the screen assembly comprising alternating reactive screens and inert screens, the reactive screens including a catalytic coating for assisting with decomposing the monopropellant, the inert screens providing structural support for the screen assembly; and
at least one valve for controlling delivery of the monopropellant into the catalyst bed at more than one flow rate for allowing the catalyst bed to decompose the monopropellant at the more than one flow rates; and
a vortex combustion chamber in fluid communication with the catalyst bed and configured to receive the decomposed monopropellant from the catalyst bed, the decomposed monopropellant assisting with generating thrust.

2. The vortex thruster system of claim 1, wherein the catalytic coating of the reactive screen comprises a silver plating coated with samarium oxide.

3. The vortex thruster system of claim 1, wherein the catalyst bed further includes at least one baffle ring positioned along an inner wall of the inner chamber to at least one of maintain a packing pressure of the screen assembly and divert monopropellant away from the inner wall of the catalyst bed.

4. The vortex thruster system of claim 3, wherein the packing pressure is approximately 2000 psi.

5. The vortex thruster system of claim 1, wherein at least one of the inert screens and at least one of the reactive screens include a fine weave configuration.

6. The vortex thruster system of claim 5, wherein the fine weave configuration includes a 50×50 mesh count.

7. The vortex thruster system of claim 5, wherein at least one of the inert screens and at least one of the reactive screens include a coarse weave configuration.

8. The vortex thruster system of claim 7, wherein the coarse weave configuration includes a 10×10 mesh count.

9. The vortex thruster system of claim 1, wherein the reactive screens include a first reactive screen including a fine weave configuration and a second reactive screen including a coarse weave configuration, the first reactive screen being positioned upstream from the second reactive screen.

10. The vortex thruster system of claim 1, further comprising a heating element positioned along an outer perimeter of the catalyst bed, the heating element configured to assist with controlling a rate of heat loss of the catalyst bed.

11. The vortex thruster system of claim 1, wherein the at least one valve comprises a first valve and a second valve, the first valve being configured to deliver the monopropellant into the catalyst bed at a first flow rate, the second valve being configured to deliver the monopropellant into the catalyst bed at a second flow rate, the second flow rate being greater than the first flow rate.

12. The vortex thruster system of claim 11, wherein the delivery of the monopropellant at the second flow rate generates a greater thrust compared to delivery of the monopropellant at the first flow rate.

13. The vortex thruster system of claim 1, wherein the monopropellant is hydrogen peroxide or hydrazine.

14. A method of a vortex thruster system, comprising:
receiving monopropellant at a first flow rate into an inner chamber of a catalyst bed of the vortex thruster system, the catalyst bed comprising a screen assembly positioned within the inner chamber of the catalyst bed, the screen assembly comprising alternating reactive screens and inert screens, the reactive screens including a catalytic coating for assisting with decomposing the monopropellant, the inert screens providing structural support for the screen assembly;
decomposing the monopropellant flowing through the screen assembly of the catalyst bed; and
delivering the decomposed monopropellant into a vortex combustion chamber of the vortex thruster system to assist with generating a first thrust level.

15. The method of claim 14, further comprising;
exposing, before operating the vortex thruster system, the screen assembly to decomposed hydrogen peroxide to activate the reactive screens.

16. The vortex thruster system of claim 14, wherein the catalytic coating of the reactive screen comprises a silver-plating coated in samarium oxide.

17. The vortex thruster system of claim 14, wherein the catalyst bed further includes at least one baffle ring positioned along an inner wall of the inner chamber to at least one of maintain a packing pressure of the screen assembly and divert monopropellant away from an inner wall of the catalyst bed.

18. The vortex thruster system of claim 14, wherein the reactive screens include a first reactive screen including a fine weave configuration and a second reactive screen including a coarse weave configuration, the first reactive screen being positioned upstream from the second reactive screen.

19. The method of claim 14, further comprising:
activating a second monopropellant valve to deliver the monopropellant at a second flow rate to the catalyst bed, the second flow rate being greater than the first flow rate.

20. The method of claim 19, wherein delivery of the monopropellant at the second flow rate creates a second thrust level that is greater than the first thrust level.
